(19) United States
(12) Patent Application Publication
(10) Pub. No.: US 2011/0103326 A1
(43) Pub. Date: May 5, 2011

(54) METHOD OF OPERATING USER EQUIPMENT IN WIRELESS COMMUNICATION SYSTEM USING A PLURALITY OF UPLINK FREQUENCIES

(76) Inventors: Sun Hee Kim, Gyeonggi-do (KR); Kyung Jun Lee, Gyeonggi-do (KR); Seung June Yi, Gyeonggi-do (KR); Sung Hoon Jung, Gyeonggi-do (KR); Sung Duck Chun, Gyeonggi-do (KR); Sung Jun Park, Gyeonggi-do (KR)

(21) Appl. No.: 12/914,172

(22) Filed: Oct. 28, 2010

Related U.S. Application Data
(60) Provisional application No. 61/256,294, filed on Oct. 29, 2009.
(60) Provisional application No. 61/257,427, filed on Nov. 2, 2009.

(30) Foreign Application Priority Data
Oct. 4, 2010 (KR) 10-2010-0096277

(51) Int. Cl. H04W 4/00

(52) U.S. Cl. 370/329

(57) ABSTRACT

A method of operating a user equipment in a wireless communication system using a plurality of uplink frequencies is disclosed. The method of operating the user equipment in the wireless communication system using the plurality of uplink frequencies includes identifying deactivation of a specific uplink frequency among the plurality of uplink frequencies, and flushing a Hybrid Automatic Repeat reQuest (HARQ) process associated with the specific uplink frequency.

This application claims the benefit of Korean Patent Application No. 10-2010-0096277, filed on Oct. 4, 2010, which is hereby incorporated by reference as if fully set forth herein.

This application also claims the benefit of U.S. Provisional Application Ser. No. 61/256,294, filed on Oct. 29, 2009, and 61/257,427, filed on Nov. 2, 2009, the content of which is hereby incorporated by reference herein in their entirety.

### BACKGROUND OF THE INVENTION

1. Field of the Invention

The present invention relates to a wireless communication system, and more particularly, to a method of operating a user equipment in a wireless communication system using a plurality of uplink frequencies.

2. Discussion of the Related Art

First, a network structure of a Universal Mobile Telecommunications System (UMTS) will be described with reference to FIG. 1.

FIG. 1 is a diagram showing a network structure of a UMTS. As shown in FIG. 1, the UMTS includes a user equipment (UE), a UMTS terrestrial radio access network (UTRAN) and a core network (CN). The UTRAN includes one or more radio network sub-systems (RNSs) and each RNS includes one radio network controller (RNC) and one or more base stations (Node Bs) managed by the RNC. One or more cells may exist per base station.

Next, the structure of a radio protocol used in the UMTS will be described with reference to FIG. 2. FIG. 2 is a diagram showing the structure of the radio protocol used in the UMTS. Pairs of radio protocol layers exist in the UE and the UTRAN and perform data transfer over an air interface. In the radio protocol layers, a physical (PHY) layer, which is a first layer, is responsible for data transfer over an air interface using various radio transfer technologies. The PHY layer is connected to a medium access control (MAC) layer, which is a higher layer, through a transport channel, and the transport channel is divided into a dedicated transport channel and a common transport channel depending on whether or not the channel is shared.

A MAC layer, a radio link control (RLC) layer and a broadcast and multicast control (BMC) layer exist in a second layer. The MAC layer maps various logical channels to various transport channels and performs logical channel multiplexing to map a plurality of logical channels to one transport channel.

The MAC layer is connected to the RLC layer, which is a higher layer, through a logical channel. The logical channel is divided into a control channel for transmitting information on a control plane and a traffic channel for transmitting information on a user plane, according to the kind of transmitted information. Examples of the control channel include a Common Control Channel (CCCH) logical channel for transmitting common control information, a Dedicated Control Channel (DCCH) logical channel for transmitting control information to a specific UE, a Broadcast Control Channel (BCCH) logical channel for receiving system information commonly applied to a cell, a Paging Control Channel (PCCH) for receiving a paging message, etc. A Dedicated Traffic Channel (DTCH) for transferring data of the user plane to a specific UE exists in the traffic channel.

In addition, the MAC layer is divided into a MAC-b sublayer, a MAC-d sublayer, a MAC-c/sh sublayer, a MAC-hs/ehs sublayer, and a MAC-e/es or a MAC-i/is sublayer, according to the kind of the managed transport channel. The MAC-b sublayer is responsible for management of a Broadcast Channel (BCH) which is a transport channel for broadcasting system information, the MAC-c/sh sublayer is responsible for management of a Forward Access Channel (FACH) common transport channel shared with the other UEs, and the MAC-d sublayer is responsible for management of a Dedicated Channel which is a dedicated transport channel of a specific UE. In addition, the MAC-hs/ehs sublayer manages a High Speed Downlink Shared Channel (HS-DSCH) for high-speed downlink data transmission and the MAC-e/es or MAC-i/is sublayer manages an Enhanced Dedicated Channel (E-DCH) which is a transport channel for high-speed uplink data transmission.

The RLC layer guarantees Quality of Service (QoS) of a Radio Bearer (RBs) or data transmission. The RLC has one or two independent RLC entities for each RB in order to guarantee the QoS of the RB. In order to guarantee various QoSs, three operation modes, i.e., a Transparent Mode (TM), an Unacknowledged Mode (UM), and an Acknowledged Mode (AM), are provided. In addition, the RLC is responsible for adjustment of a data size to suit data transmission over an air interface and is responsible for segmentation and concatenation of data received from a higher layer.

A Packet Data Convergence Protocol (PDCP) layer is located at a high level of the RLC layer and enables data transmitted as IP packets such as IPv4 or IPv6 packets to be efficiently transmitted over an air interface with a narrow bandwidth. The PDCP layer performs a header compression function to transmit only necessary information in a header part of data, thereby increasing transfer efficiency of the air interface. Since the PDCP layer has header compression as a basic function, the PDCP layer exists in a packet switched (PS) region and one PDCP entity exists per RB in order to provide an efficient header compression function to each PS service. However, if the PDCP layer exists in a circuit switched (CS) region, the header compression function is not provided.

In the second layer, a Broadcast/Multicast Control (BMC) layer is located at a level above the RLC layer so as to perform a function for scheduling a cell broadcast message and broadcasting the cell broadcast message to UEs located in a specific cell.

A Radio Resource Control (RRC) layer located at the lowermost level of the third layer is defined only in the control plane and is responsible for control of the parameters of the first layer and the second layer in association with configuration, re-configuration and release of Radio Bearers (RBs), and is responsible for control of the logical, transport and physical channels. The RB is a logical path that the first and second layers of the radio protocol provide for data communication between the UE and the UTRAN. Generally, Radio Bearer (RB) configuration means that a radio protocol layer necessary to provide a specific service and channel characteristics are defined and their detailed parameters and operation methods are configured.

Next, dual cell High Speed Packet Access (HSPA) will be described. Dual cell HSPA is a protocol for transmitting data, which was transmitted by a UE through an E-DCH using only one frequency in the past, using two frequencies so as to increase double the transmission rate of E-DCH in the related art. An operation for transmitting data using two frequencies by the UE is referred to as a dual cell E-DCH operation. Alternatively, simultaneous communication between a UE and a base station using a plurality of frequencies or carriers is referred to as carrier aggregation.

During the dual cell E-DCH operation or carrier aggregation, a secondary frequency or a certain carrier may be activated or deactivated according to the data transmission rate. However, if a UE transmits last data stored in a buffer of the UE to a network through an activated secondary uplink frequency using a Hybrid Automatic Repeat reQuest (HARQ) operation, and, if the network successfully receives the data, the network transmits an ACK signal to the UE as HARQ feedback information. The network may deactivate the secondary uplink frequency. However, if the UE erroneously determines that the HARQ feedback information is a NACK signal, the UE does not delete the transmitted data and thus the data is present in the buffer of the HARQ process corresponding to the deactivated secondary uplink frequency. Thereafter, if the network reactivates the secondary uplink frequency, the UE unnecessarily retransmit the data present in the HARQ buffer. That is, radio resource waste and interference occur due to unnecessary retransmission.

The UE determines the size of a transport block based on the amount of data stored in the buffer of the UE, the amount of power used for the transmission of the UE, and a grant value transmitted from the network to the UE. The UE updates a serving grant value, which is a state variable, using the grant value received from the network.

According to the related art, if the network reactivates the deactivated secondary uplink frequency of the UE, the UE does not initialize the value of the serving grant and maintains the previous value. If the network receives last data from the UE, deactivates the secondary uplink frequency of the UE, and then reactivates the secondary uplink frequency, the serving grant value is equal to the value when the UE transmits the last data. However, a radio environment when the UE reactivates the secondary uplink frequency may be different from a radio environment when the UE transmits the last data. For example, even when the power used to transmit data before the secondary uplink frequency of the UE is deactivated is greater than the power when the secondary uplink frequency is reactivated, the UE transmits data using the power used before the secondary uplink frequency is deactivated, when the secondary uplink frequency is reactivated. This leads to interference with other UEs.

As described above, according to the related art, when a secondary uplink frequency is activated or deactivated, radio resource waste and interference occur due to unnecessary retransmission. In addition, since a serving grant value is not updated, interference occurs.

### SUMMARY OF THE INVENTION

Accordingly, the present invention is directed to a method of operating an user equipment in a wireless communication system using a plurality of uplink frequencies that substantially obviates one or more problems due to limitations and disadvantages of the related art.

An object of the present invention is to provide a method of operating an user equipment, which is capable of efficiently utilizing radio resources and preventing interference from occurring when a secondary uplink frequency is activated or deactivated.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of operating a user equipment in a wireless communication system using a plurality of uplink frequencies includes identifying deactivation of a specific uplink frequency among the plurality of uplink frequencies, and flushing a Hybrid Automatic Repeat reQuest (HARQ) process associated with the specific uplink frequency.

The user equipment may receive information indicating the deactivation of the specific uplink frequency.

The information indicating the deactivation of the specific uplink frequency may be a High Speed-Shared Control Channel Order (HS-SCCH) for the specific uplink frequency.

The plurality of uplink frequencies may comprise a primary uplink frequency and a secondary uplink frequency, and the specific uplink frequency may be the secondary uplink frequency.

The primary uplink frequency may remain active at all times.

In another aspect of the present invention, a user equipment of a wireless communication system using a plurality of uplink frequencies includes a processor configured to flush a Hybrid Automatic Repeat reQuest (HARQ) process associated with a specific uplink frequency, upon identifying deactivation of the specific uplink frequency among the plurality of uplink frequencies.

In another aspect of the present invention, in a method of operating a user equipment in a wireless communication system using a plurality of uplink frequencies, the plurality of uplink frequencies comprises a primary uplink frequency and a secondary uplink frequency, and the method comprises identifying deactivation of the secondary uplink frequency, and clearing a serving grant of the secondary uplink frequency.

The clearing of the serving grant may initialize at least one of a variable and a timer associated with the serving grant of the secondary uplink frequency.

The UE may receive information indicating activation of the secondary uplink frequency from a base station.

The information indicating the activation of the secondary uplink frequency may be a High Speed-Shared Control Channel (HS-SCCH) order.

The user equipment may receive a new serving grant of the secondary uplink frequency through the information indicating the activation of the secondary uplink frequency, and configure the serving grant of the secondary uplink frequency to the received new serving grant.

In another aspect of the present invention, in a user equipment in a wireless communication system using a plurality of uplink frequencies, the plurality of uplink frequencies comprises a primary uplink frequency and a secondary uplink frequency, and the user equipment comprises a processor configured to clear a serving grant of the secondary uplink frequency upon identifying deactivation of the secondary uplink frequency.

According to the embodiments of the present invention, it is possible to efficiently utilize radio resources and to prevent interference.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram showing a network structure of a Universal Mobile Telecommunications System (UMTS);

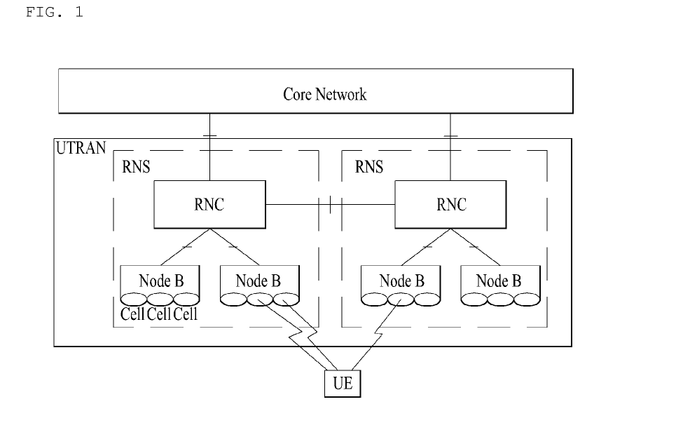

FIG. 2 is a diagram showing a structure of a radio protocol used in a UMTS;

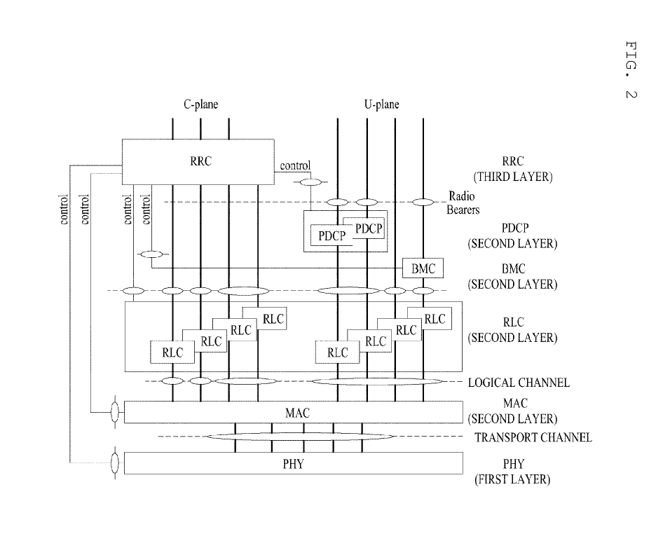

FIG. 3 is a diagram showing dual cell High Speed Packet Access (HSPA) technology;

FIG. 4 is a diagram showing a dual cell E-DCH structure of a user equipment (UE);

FIG. 5 is a diagram showing a state in which a base station activates and deactivates a secondary uplink frequency of a UE;

FIG. 6 is a diagram showing a process of updating a serving grant which is a state variable;

FIG. 7 is a flowchart illustrating a method of operating a UE when a secondary uplink frequency is deactivated, according to a first embodiment of the present invention;

FIG. 8 is a diagram showing an example of the method of operating the UE when the secondary uplink frequency is deactivated, according to the first embodiment of the present invention;

FIG. 9 is a flowchart illustrating a method of operating a UE when a secondary uplink frequency is activated, according to a second embodiment of the present invention; and

FIG. 10 is a diagram showing the configuration of a transmitter and a receiver in which the embodiments of the present invention can be implemented.

### DETAILED DESCRIPTION OF THE INVENTION

Hereinafter, the preferred embodiments of the present invention will be described with reference to the accompanying drawings. It is to be understood that the detailed description which will be disclosed along with the accompanying drawings is intended to describe the exemplary embodiments of the present invention, and is not intended to describe a unique embodiment through which the present invention can be carried out. Hereinafter, the detailed description includes detailed matters to provide full understanding of the present invention. However, it will be apparent to those skilled in the art that the present invention can be carried out without the detailed matters. For example, the following description will be given on the assumption a Universal Mobile Telecommunications System (UMTS) is used, but the present invention is applicable to other mobile communication systems excluding the unique matters of the UMTS.

In some instances, well-known structures and devices are omitted in order to avoid obscuring the concepts of the present invention and the important functions of the structures and devices are shown in block diagram form. The same reference numbers will be used throughout the drawings to refer to the same or like parts.

In the following description, it is assumed that a terminal includes a mobile or fixed user end device such as a user equipment (UE) and a mobile station (MS), and a base station includes a node of a network end communicating with a terminal, such as a Node-B, an eNode B, and a base station.

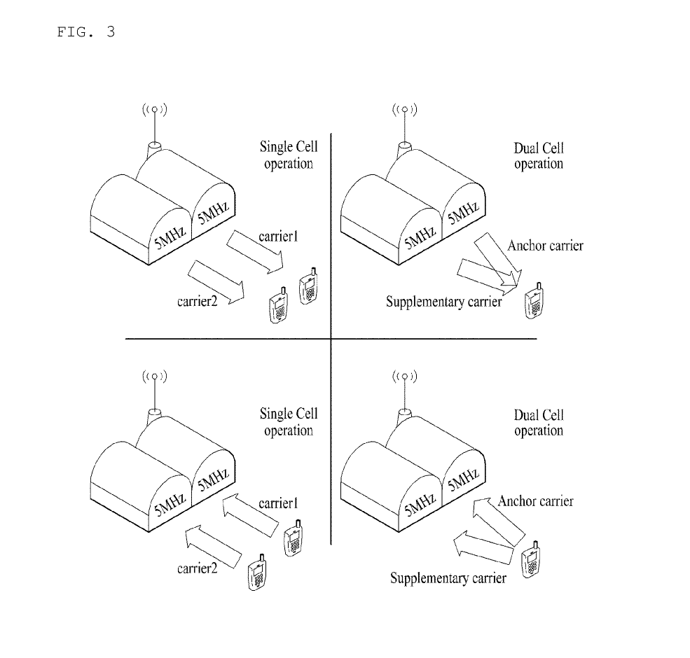

First, dual cell High Speed Packet Access (HSPA) will be described with reference to FIG. 3.

FIG. 3 is a diagram showing dual cell HSPA technology.

As shown in FIG. 3, in the related art, a UE transmits an Enhanced Dedicated Channel (E-DCH) using one frequency. However, in the dual cell HSPA, the UE simultaneously transmits data using two frequencies such that data transmission rate increases to twice that of the related art. In the dual cell HSPA, the UE may transmit data at a maximum of 20 Mbps, and an operation for transmitting data using two frequencies by the UE is referred to as a dual cell E-DCH operation.

In addition, in the related art, even in downlink, the UE receives a High Speed Downlink Shared Channel (HS-DSCH) using one frequency. However, in the dual cell HSPA, one UE receives data using two frequencies so as to double data reception rate. In the dual call HSPA, the UE may receive data at a maximum of 80 Mbps, and an operation for simultaneously receiving data using two frequencies is referred to as a dual cell HSPA operation.

As a method similar to the dual cell HSPA, carrier aggregation may be used. Carrier aggregation aggregates a plurality of carriers so as to extend a bandwidth in order to increase a data rate. For example, in a Long Term Evolution (LTE) system, one carrier has a bandwidth of 20 MHz. In contrast, in a LTE-Advanced (LTE-A) system, five carriers each having 20 MHz are aggregated so as to increase the bandwidth to 100 MHz. Carrier aggregation includes aggregation of carriers located in different frequency bands.

Multi-carrier indicates the entire frequency band used by the base station. For example, in the LTE-A system, multi-carrier has a bandwidth of 100 MHz. A component carrier indicates an element carrier configuring the multi-carrier. That is, a plurality of component carriers configures the multi-carrier through carrier aggregation.

The present invention is applicable to the case where a UE transmits uplink data to a base station using a plurality of frequencies, such as dual cell HSPA and carrier aggregation.

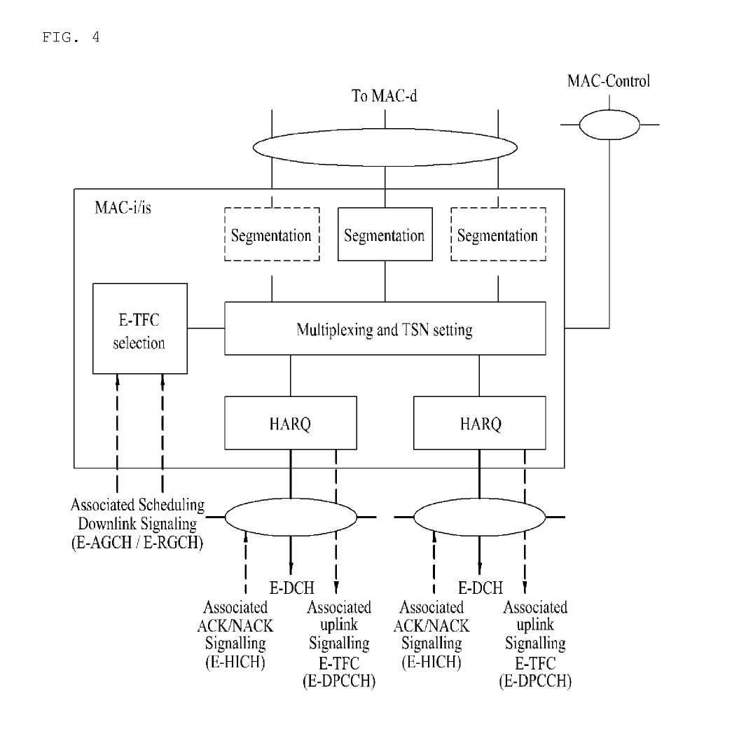

FIG. 4 is a diagram showing a dual cell E-DCH structure of a UE. Since the dual cell E-DCH supports an uplink through two frequencies and one HARQ entity manages one uplink, an operation associated with two HARQ entities is performed in a dual cell E-DCH system. In addition, since the UE independently processes transport blocks by respective HARQ entities, the UE may simultaneously transmit the respective transport blocks using two frequencies through the dual cell E-DCH. A control channel and a traffic channel exist for each frequency. When the UE transmits data through the E-DCH, an uplink frequency exists for each E-DCH, and a downlink signal received from a network, for uplink data transmission, exists for each frequency. An acknowledgement/non-acknowledgement (hereinafter, referred to as “ACK/NACK”) signal of the data transmitted through each E-DCH is received through each E-HICH. The network transmits a grant value, which indicates the amount of data to be transmitted through each E-DCH, through an Enhanced Absolute Grant Channel (E-AGCH) for each frequency. In addition, since interference between the transmitted data occurs, an Enhanced Relative Grant Channel (E-RGCH) that instructs the increase or decrease of the grant value, which will be used when transmitting the data, exists for each frequency.

The uplink is always set to be identical to the downlink. Similar to the dual cell E-DCH, the UE may receive data using one or more frequencies in downlink. At this time, a High Speed Dedicated Physical Control Channel (HS-DPCCH) for transmitting a response message to data received using a plurality of frequencies is transmitted using one frequency. This uplink frequency is referred to as a primary uplink frequency. When a plurality of uplink frequencies is set, all the frequencies other than the primary uplink frequency are referred to as secondary uplink frequencies.

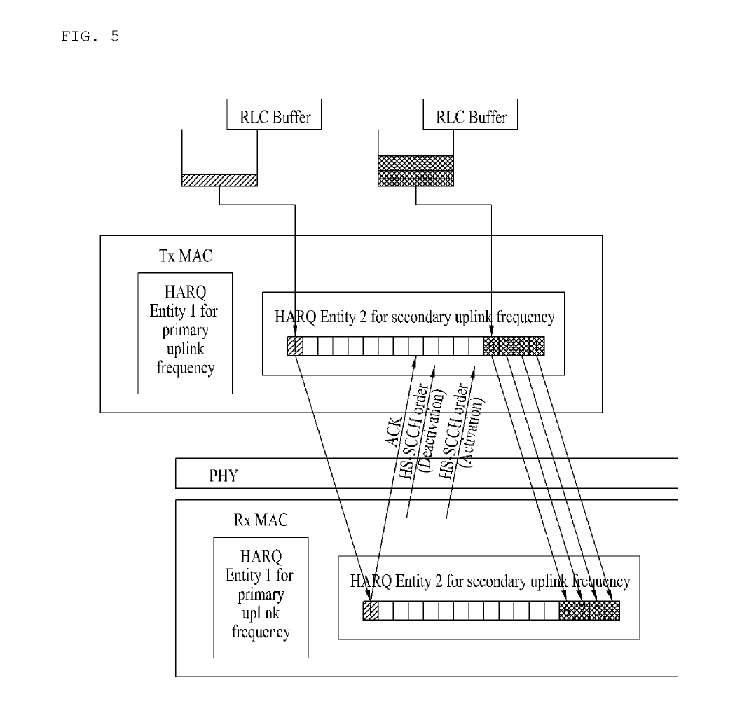

FIG. 5 is a diagram showing a state in which a base station activates and deactivates a secondary uplink frequency of a UE.

As shown in FIG. 5, in the dual cell E-DCH, the network may instruct the UE to activate or deactivate the secondary uplink frequency using a High Speed-Shared Control Channel (HS-SCCH) order. The UE monitors the HS-SCCH in every Transmission Time Interval (TTI) and receives the command for activating or deactivating the secondary uplink frequency. In general, if the amount of data to be transmitted to the network is small or data to be transmitted is not present in the buffer of the UE, the network may deactivate the secondary uplink frequency of the UE. Thereafter, if the amount of data to be transmitted to the network, which is stored in the buffer of the UE, is increased, the network reactivates the secondary uplink frequency of the UE such that the UE additionally uses the secondary uplink frequency, for data transmission. For example, if data to be transmitted to the network is not present in the buffer of the UE after the UE transmits last data present in the buffer of the UE, the network receives the last data and deactivates the secondary uplink frequency of the UE. The network generally knows information about the amount of data stored in the buffer of the UE.

When the UE transmits data using two frequencies, if the downlink channel state of the secondary uplink frequency of the UE deteriorates, the data rate of the UE is reduced, or data to be transmitted disappears, the network may deactivate the downlink of the secondary uplink frequency in TTI units. The network may configure the dual cell E-DCH at the RRC layer, that is, the RNC apparatus, and the network may rapidly deactivate the secondary uplink frequency at the PHY layer, that is, the base station apparatus, in TTI units. Thereafter, the network may reactivate the secondary uplink frequency according to the channel state of the secondary uplink frequency or the data rate. For example, if the data rate of the UE which is performing the dual cell E-DCH operation is reduced or data to be transmitted is not present, the network may deactivate the secondary uplink frequency of the UE. Thereafter, when the data to be transmitted from the UE is increased, the network may reactivate the secondary uplink frequency of the UE.

Next, a Hybrid Automatic Repeat reQuest (HARQ) transmission scheme will be described. In the E-DCH, the HARQ scheme is used in order to increase the probability of the transmitted data successfully arriving at the receiver and to reduce transmit power. According to the HARQ scheme, the receiver transmits an ACK/NACK signal, indicating whether or not the receiver has received data transmitted by the transmitter, to the transmitter.

For example, the UE transmits a first packet to the base station through a physical channel, and the base station transmits an ACK signal when the first packet is received and transmits a NACK signal when the first packet is not received. The UE transmits a second packet, which is new data, to the base station when receiving the ACK signal from the base station, and retransmits the first packet when receiving the NACK signal. Then, the base station attempts to receive a combination of the initially transmitted first packet and the retransmitted first packet from the UE, transmits an ACK signal to the UE if decoding is successfully performed, and transmits a NACK signal to the UE if decoding is not successfully performed. In the UE which performs dual cell HSPA, such a HARQ entity exists for each frequency and a HARQ process and a HARQ process buffer corresponding to each frequency exists.

Next, E-DCH data transmission will be described.

The UE determines the size of the transport block to be transmitted in a next TTI based on the amount of data stored in the buffer of the UE, the amount of power used for the transmission of the UE, and a grant transmitted from the network to the UE. The UE updates a serving grant value, which is a state variable, using the grant received from the network. The absolute grant transmitted from the network through the E-AGCH is an index indicating maximum E-DCH traffic (power ratio of E-DPDCH/DPCCH) which may be used by a specific UE in the next TTI using an index. For example, the absolute grant 14 denotes (60/15)̂2. In addition, the absolute grant 1 denotes “zero grant”. “Zero grant” means that the network does not transmit any data to the UE.

In addition, the relative grant transmitted from the network through the E-RGCH instructs the UE to decrease or increase UE transmit power. The radio link of the network for transmitting the relative grant is largely divided into two radio links. A serving radio link (RL) refers to a radio link in which handover of the E-DCH is possible and a non serving RL refers to a radio link in which handover is impossible but the UE is affected by interference when the UE transmits uplink data.

A message indicating that the value of the serving grant is “UP”, “HOLE” or “DOWN” may be received through the E-RGCH received from the serving radio link. Then, the UE decreases or increases the value of the serving grant by 2 or 3 levels according to setting, and updates the value of the serving grant. In addition, a message indicating that the value of the serving grant is “DOWN” may be received through the E-RGCH received from the non serving radio link. If the UE does not receive the grant value but receives a message indicating that the previously received grant value must be increased or decreased, the UE increases or decreases the serving grant value, which is the state variable, one by one so as to update the serving grant value, according to setting.

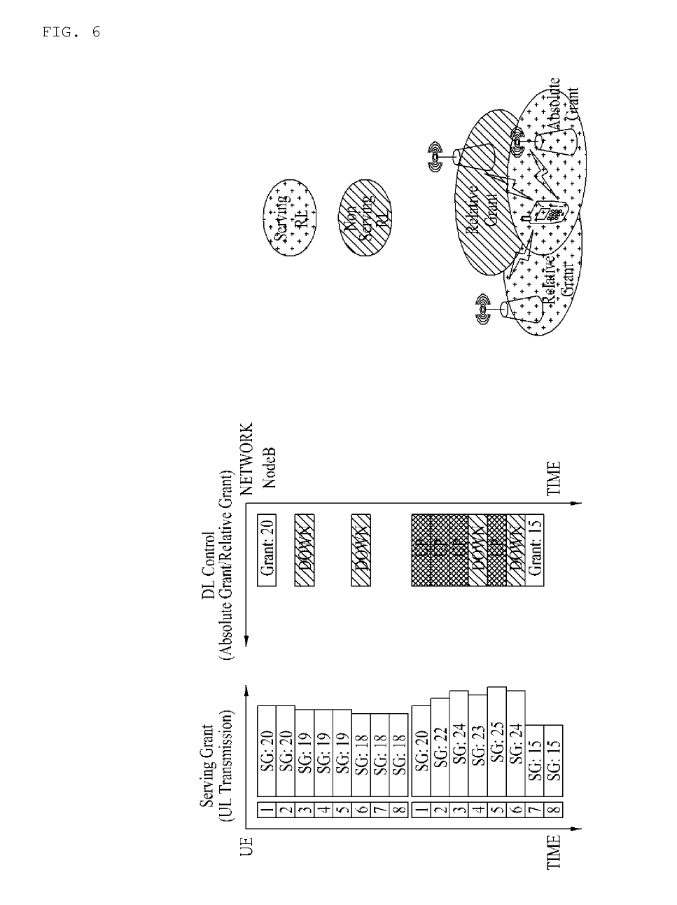

FIG. 6 is a diagram showing a process of updating a serving grant which is a state variable. Referring to FIG. 6, the UE receives the absolute grant 20 and sets the serving grant to 20. Thereafter, the serving grant is updated according to the received relative grant.

The UE determines the maximum size of the transport block which can be transmitted by the UE in a next TTI using the serving grant which is the state variable. Thereafter, the remaining amount of power used for transmission of the UE is computed, and then an E-DCH Transport Format Combination Indicator (E-TFCI) which can be transmitted by the UE through the E-DCH is selected. If a specific E-TFCI is selected, the size of the transport block of the E-TFCI is decided. For example, E-TFCI is 199 bits. Thereafter, the UE determines the transport block size and the transmit power through the selected E-TFCI.

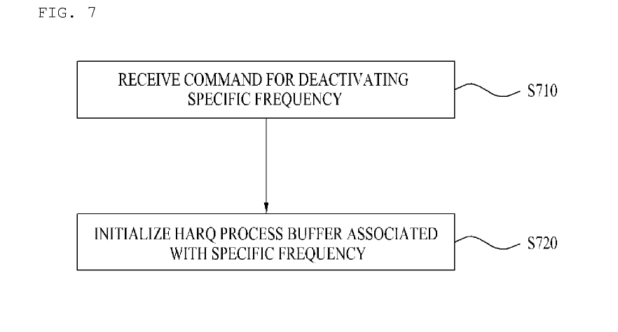

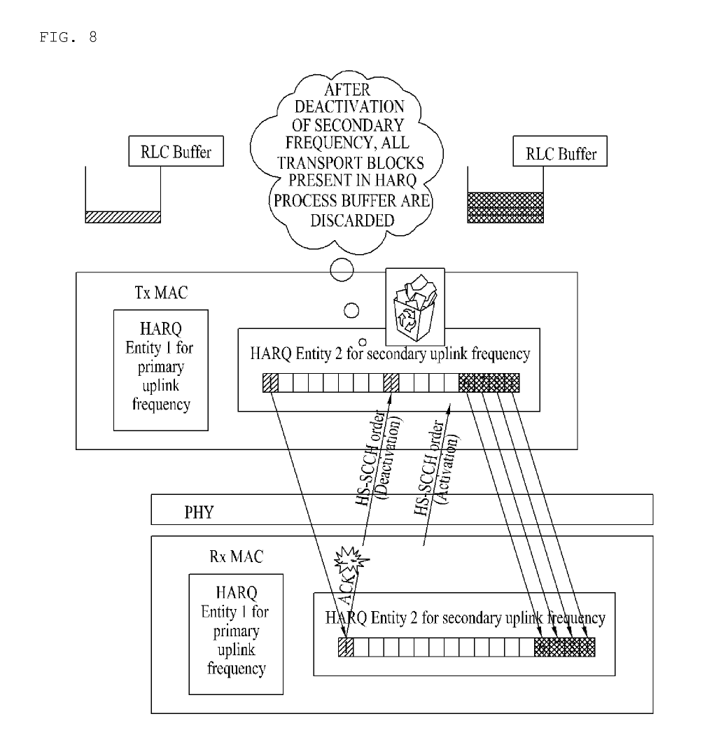

Next, a method of operating a UE when a secondary uplink frequency is deactivated according to a first embodiment of the present invention will be described with reference to FIGS. 7 and 8.

FIG. 7 is a flowchart illustrating the method of operating the UE when the secondary uplink frequency is deactivated, according to the first embodiment of the present invention, and FIG. 8 is a diagram showing an example of the method of operating the UE when the secondary uplink frequency is deactivated, according to the first embodiment of the present invention.

According to the first embodiment of the present invention, in the case where the UE uses a plurality of frequencies, for uplink data transmission, if the UE determines that a specific frequency is deactivated, the UE discards data present in the buffer of the HARQ process associated with the deactivated frequency.

In the dual cell E-DCH operation of the UMTS, the plurality of frequencies which is used by the UE for uplink data transmission may be divided into a primary uplink frequency and a secondary uplink frequency. Only the secondary uplink frequency may be activated or deactivated.

Referring to FIG. 7, the UE receives a command for deactivating a specific frequency from the base station (S710).

In the UMTS, the UE receives the HS-SCCH order for deactivating the secondary uplink frequency from the base station. The UE monitors the HS-SCCH in every TTI and receives the HS-SCCH order. The UE decodes the HS-SCCH order received through the HS-SCCH using an Enhanced Radio Network Temporary Identifier (E-RNTI) of the UE.

The UE successfully performs the decoding of the HS-SCCH order and determines that the secondary uplink frequency is deactivated, if an indicator indicating the deactivation of the secondary uplink frequency is present in the HS-SCCH order.

The UE initializes the HARQ process buffer associated with the specific frequency which is instructed to be deactivated by the base station (S720).

One independent HARQ entity exists for each of the plurality of uplink frequencies, and the HARQ entity manages a plurality of HARQ processes. The UE discards data present in all HARQ process buffers of the HARQ entity associated with the deactivated secondary uplink frequency. The data present in the buffer of the HARQ process refers to a MAC PDU or a transport block.

In the first embodiment of the present invention, the UE discards the data of the HARQ process buffer of the HARQ entity associated with the secondary uplink frequency when the secondary uplink frequency is deactivated. However, the UE may discard the data of the HARQ process buffer of the HARQ entity associated with the secondary uplink frequency when the deactivated secondary uplink frequency is reactivated.

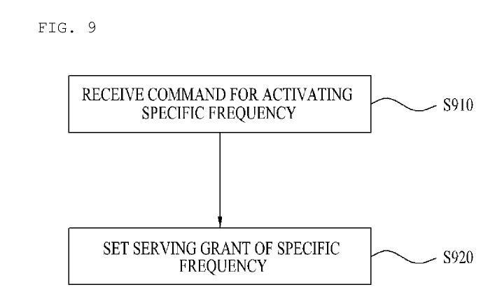

Next, a method of operating a UE when a secondary uplink frequency is activated according to a second embodiment of the present invention will be described with reference to FIG. 9. FIG. 9 is a flowchart illustrating the method of operating the UE when the secondary uplink frequency is activated, according to the second embodiment of the present invention.

In the second embodiment of the present invention, a method of setting a serving grant of a secondary uplink frequency by the UE when the secondary uplink frequency of the UE is deactivated and then reactivated in the case where the UE transmits uplink data using a plurality of frequencies is proposed.

As shown in FIG. 9, the UE receives a command for activating a specific frequency from the base station (S910).

In the UMTS, the UE receives the HS-SCCH order for activating the secondary uplink frequency from the base station. The UE monitors the HS-SCCH in every TTI and receives the HS-SCCH order. The UE decodes the HS-SCCH order received through the HS-SCCH using an Enhanced Radio Network Temporary Identifier (E-RNTI) of the UE.

The UE successfully performs the decoding of the HS-SCCH order and determines that the secondary uplink frequency is activated, if an indicator indicating activation of the secondary uplink frequency is present in the HS-SCCH order.

The UE sets the serving grant of the specific frequency (S920).

The UE determines the size of the transport block to be transmitted through the specific frequency using the serving grant which is the state variable. Accordingly, if the specific frequency is activated, the serving grant, which is the state variable, of the specific frequency must be set in order to determine the size of the transport block to be transmitted through the specific frequency. In the second embodiment of the present invention, two methods for setting the serving grant are proposed.

In a first method, when the secondary uplink frequency of the UE is activated, the network sends the serving grant value to be used after the secondary uplink frequency is activated. Alternatively, when the secondary uplink frequency is deactivated, the network may send the serving grant value to be used after reactivation. If the secondary uplink frequency is activated, the UE sets the serving grant, which is the state variable, to the serving grant value received from the network. The size of the transport block to be transmitted through the secondary uplink frequency is determined using the serving grant set to the serving grant value received from the network.

The serving grant value of the secondary uplink frequency may be different from the serving grant value of the primary uplink frequency. The network may send the serving grant value through a higher layer message. The higher layer message may be the existing RRC message (e.g., a radio bearer setup message, a radio bearer reconfiguration message, or an active set update message). For example, the network may send the serving grant value using an E-DCH Information Element (IE) in the existing RRC message. Alternatively, the network may send the serving grant value using a new message.

In a second method, when the secondary uplink frequency is activated or deactivated, the UE sets the serving grant. The size of the transport block which will be initially transmitted through the secondary uplink frequency is determined using the set serving grant.

The UE may set the serving grant to zero grant when the secondary uplink frequency is activated or deactivated.

Alternatively, the serving grant of the secondary uplink frequency may be set to the sum of the serving grant of the primary uplink frequency and an offset. The offset value may be set by the network and the UE may be informed of the set offset value or may be pre-negotiated between the UE and the network. If the offset value is 0, the serving grant of the primary uplink frequency becomes equal to the serving grant value of the secondary uplink frequency.

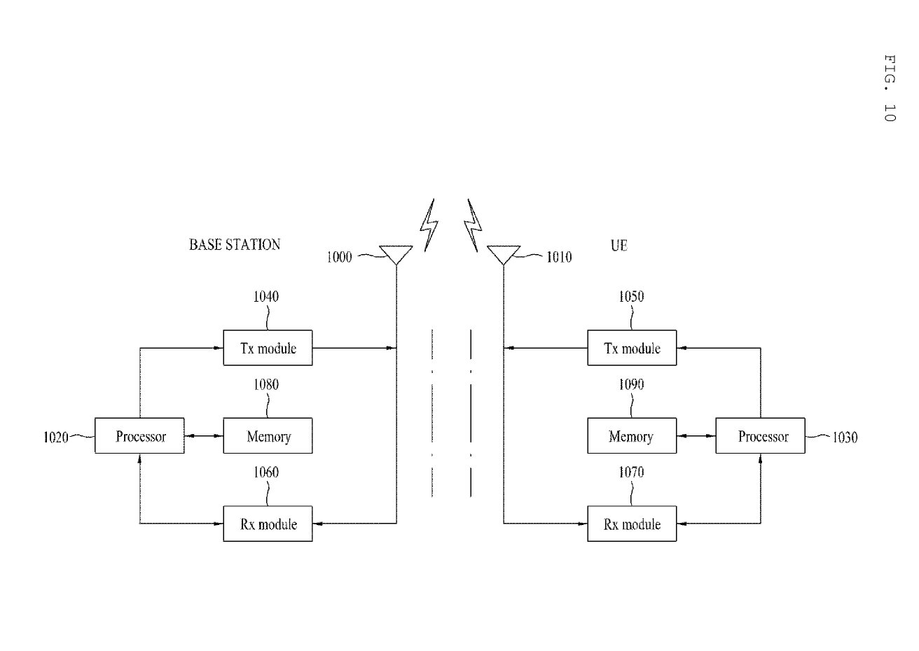

FIG. 10 is a diagram showing the configuration of a transmitter and a receiver in which the above-described embodiments of the present invention can be implemented, as another embodiment of the present invention.

The transmitter and the receiver include antennas 1000 and 1010 for transmitting and receiving information, data, signals and/or messages, transmission (Tx) modules 1040 and 1050 for controlling the respective antennas so as to transmit messages, reception (Rx) modules 1060 and 1070 for controlling the respective antennas so as to receive messages, memories 1080 and 1090 for storing information associated with the communication with the base station, and processors 1020 and 1030 for controlling the Tx modules, the Rx modules and the memories, respectively.

The antennas 1000 and 1010 serve to transmit the signals generated by the Tx modules 1040 and 1050 to external devices or to receive RF signals from external devices and deliver the signals to the Rx modules 1060 and 1070. If a Multi-Input Multi-Output (MIMO) function is supported, two or more antennas may be included.

The processors 1020 and 1030 control the overall operations of the transmitter and the receiver. In particular, the processor may perform a control function for implementing the embodiments of the present invention, a MAC frame variable control function according to service characteristics and propagation environments, a handover function, an authentication and encryption function, etc. In addition, the processors 1020 and 1030 may further include encryption modules for controlling the encryption of various messages and timer modules for controlling transmission/reception of various messages.

When the UE receives the command for deactivating a specific uplink frequency among a plurality of uplink frequencies from the base station, the processor 1020 of the UE initializes the HARQ process buffer associated with the specific uplink frequency. That is, all the data of the HARQ process buffer associated with the specific uplink frequency is discarded. Alternatively, the processor 1030 of the UE may initialize the HARQ process buffer associated with the specific uplink frequency when the UE receives the command for reactivating the specific uplink frequency among the plurality of uplink frequencies from the base station.

When the UE receives the command for activating the specific uplink frequency among the plurality of uplink frequencies from the base station, the processor 1030 of the UE sets the serving grant of the specific uplink frequency.

When the UE receives the serving grant value from the base station, the processor 1030 of the UE sets the serving grant of the specific uplink frequency to the received serving grant value. If the serving grant value is not received from the base station, the serving grant of the specific uplink frequency is set to zero grant.

The Tx modules 1040 and 1050 may perform predetermined coding and modulation with respect to signals and/or data which are scheduled by the processors and are transmitted to the external devices, and send the signals and/or data to the antennas 1000 and 1010.

The Tx module 1040 of the base station transmits the HS-SCCH order for activating or deactivating the specific uplink frequency among the plurality of uplink frequencies to the UE.

The Rx modules 1060 and 1070 may perform decoding and demodulation with respect to the RF signals received through the antennas 1000 and 1010, restore the signals to the format of original data, and send the signals to the processors 1020 and 1030.

The Rx module 1070 of the UE receives the HS-SCCH order for activating or deactivating the specific uplink frequency among the plurality of uplink frequencies from the base station.

The Rx module 1070 of the UE may receive the serving grant value to be used after the specific uplink frequency is reactivated, upon receiving the HS-SCCH order for reactivating or deactivating the specific uplink frequency from the base station.

The memories 1080 and 1090 may store programs for processing and control of the processors and perform a function for temporarily storing input/output data (in case of the UE, the uplink (UL) grant allocated by the base station, system information, a station identifier (STID), a flow identifier (FID), an action time, region allocation information, frame offset information, etc.).

In addition, the memories may include at least one storage medium such as a flash memory type, hard disk type, multimedia card micro type and card type memory (e.g., an SD or XD memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, and an optical disc.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of operating a user equipment in a wireless communication system using a plurality of uplink frequencies, the method comprising:
identifying deactivation of a specific uplink frequency among the plurality of uplink frequencies; and
flushing a Hybrid Automatic Repeat reQuest (HARQ) process associated with the specific uplink frequency.

2. The method according to claim 1, further comprising receiving information indicating the deactivation of the specific uplink frequency.

3. The method according to claim 2, wherein the information indicating the deactivation of the specific uplink frequency is a High Speed-Shared Control Channel Order (HS-SCCH) for the specific uplink frequency.

4. The method according to claim 1, wherein the plurality of uplink frequencies comprises a primary uplink frequency and a secondary uplink frequency, and the specific uplink frequency is the secondary uplink frequency.

5. The method according to claim 4, wherein the primary uplink frequency is always activated.

6. An user equipment of a wireless communication system using a plurality of uplink frequencies, the user equipment comprising:
a processor configured to flush a Hybrid Automatic Repeat reQuest (HARQ) process associated with a specific uplink frequency, upon identifying deactivation of the specific uplink frequency among the plurality of uplink frequencies.

7. The user equipment according to claim 6, further comprising a reception module configured to receive information indicating the deactivation of the specific uplink frequency.

8. The user equipment according to claim 7, wherein the information indicating the deactivation of the specific uplink frequency is a High Speed-Shared Control Channel (HS-SCCH) order for the specific uplink frequency.

9. The user equipment according to claim 6, wherein the plurality of uplink frequencies comprises a primary uplink frequency and a secondary uplink frequency, and the specific uplink frequency is the secondary uplink frequency.

10. The user equipment according to claim 9, wherein the primary uplink frequency is always activated.

11. A method of operating a user equipment in a wireless communication system using a plurality of uplink frequencies, wherein:
the plurality of uplink frequencies comprises a primary uplink frequency and a secondary uplink frequency, and
the method comprises:
identifying deactivation of the secondary uplink frequency; and
clearing a serving grant of the secondary uplink frequency.

12. The method according to claim 11, wherein the clearing of the serving grant initializes at least one of a variable and a timer associated with the serving grant of the secondary uplink frequency.

13. The method according to claim 11, wherein the method further comprises receiving information indicating activation of the secondary uplink frequency from a base station.

14. The method according to claim 13, wherein the information indicating the activation of the secondary uplink frequency is a High Speed-Shared Control Channel (HS-SCCH) order.

15. The method according to claim 13, wherein the method further comprises
receiving a new serving grant of the secondary uplink frequency through the information indicating the activation of the secondary uplink frequency; and
configuring the serving grant of the secondary uplink frequency to the received new serving grant.

16. A user equipment in a wireless communication system using a plurality of uplink frequencies, wherein:
the plurality of uplink frequencies comprises a primary uplink frequency and a secondary uplink frequency, and
the user equipment comprises a processor configured to clear a serving grant of the secondary uplink frequency upon identifying deactivation of the secondary uplink frequency.

17. The user equipment according to claim 16, wherein the clearing of the serving grant initializes at least one of a variable and a timer associated with the serving grant of the secondary uplink frequency.

18. The user equipment according to claim 16, wherein the user equipment further comprises a reception module configured to receive information indicating activation of the secondary uplink frequency from a base station.

19. The user equipment according to claim 18, wherein the information indicating the activation of the secondary uplink frequency is a High Speed-Shared Control Channel (HS-SCCH) order.

20. The user equipment according to claim 18, wherein:
the reception module receives a new serving grant of the secondary uplink frequency through the information indicating the activation of the secondary uplink frequency, and
the processor configures the serving grant of the secondary uplink frequency to the received new serving grant.
